(19) United States
(12) Patent Application Publication
(10) Pub. No.: US 2014/0130163 A1
(43) Pub. Date: May 8, 2014

(54) Method and Apparatus for Setting Secure Connection in Wireless Communications System

(71) Applicant: MEDIATEK INC., Hsin-Chu (TW)

(72) Inventors: Shao-Wei Chen, New Taipei City (TW); Shun-Yong Huang, Taipei City (TW); Chao-Chun Wang, Taipei City (TW); Yu-Che Tsai, Hsinchu City (TW)

(73) Assignee: MEDIATEK INC., Hsin-Chu (TW)

(21) Appl. No.: 14/033,516

(22) Filed: Sep. 22, 2013

Related U.S. Application Data
(60) Provisional application No. 61/722,787, filed on Nov. 6, 2012.

(51) Int. Cl. H04L 29/06; H04W 12/12

(52) U.S. Cl. CPC H04L 63/1416; H04W 12/12
USPC 726/23

(57) ABSTRACT

A method of setting a secure connection in a wireless communications system is disclosed. The method comprises setting a protocol information to a terminal; and checking a packet received in the terminal according to the protocol information; wherein the packet comprises a protocol type, a source port, and a destination port.

### CROSS REFERENCE TO RELATED APPLICATIONS

This application claims the benefit of U.S. Provisional Application No. 61/722,787, filed on Nov. 6, 2012, entitled “Method for protecting a communications device from receiving unsolicited data”, the contents of which are incorporated herein in their entirety.

### BACKGROUND

The present invention relates to a method and apparatus utilized in a wireless communications system, and more particularly, to a method and apparatus of setting a secure connection in a wireless communication system.

Wireless Fidelity (Wi-Fi) Display specification is a standard for a Wi-Fi technology and used in a latency-aware application for streaming in a short distance, such as a wireless local area network (WLAN). In the Wi-Fi Display application, a connection is established between a source device and a sink device. The source device encodes video contents into encoded video bit streams and sends the encoded video bit streams to the sink device. The sink device further decodes the received video bit streams and recovers to the video contents. Therefore, a user can watch the video contents on a suitable display of the sink device for the user's purpose than a display of the source device. For example, a user shares a video from a notebook computer to a large screen television so that more people can comfortably watch the video on the television together. In this example, the notebook computer is the source device and the television is the sink device (assuming the television supports Wi-Fi Display specifications), and the source device transmits video contents to the sink device for playback on a display of the sink device.

Since malwares may attack through the connection, security of the connection is important. However, a standard firewall is not useful for an embedded system with restricted computing resources including memory and processor, so that the standard firewall cannot avoid the attack. Therefore, how to set up a secure connection becomes a goal.

### SUMMARY

The present invention therefore provides a method and an apparatus for setting a secure connection in a wireless communications system, to resist the attack from the malwares and keep secure.

A method of setting a secure connection in a wireless communications system is disclosed. The method comprises setting a protocol information to a terminal in the wireless communication system; and checking a packet received in the terminal according to the protocol information; wherein the packet comprises a protocol type, a source port, and a destination port.

A communication apparatus for a wireless communications system is disclosed. The communication apparatus comprises a processing means; a storage unit; a program code, stored in the storage unit, wherein the program code instructs the processing means to execute the following steps: setting a protocol information to a terminal in the wireless communication system; and checking a packet received in the terminal according to the protocol information; wherein the packet comprises a protocol type, a source port, and a destination port.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system according to an example of the present invention.

FIG. 2 is a flowchart of a process according to an example of the present invention.

FIG. 3 is a flowchart of a process according to an example of the present invention.

### DETAILED DESCRIPTION

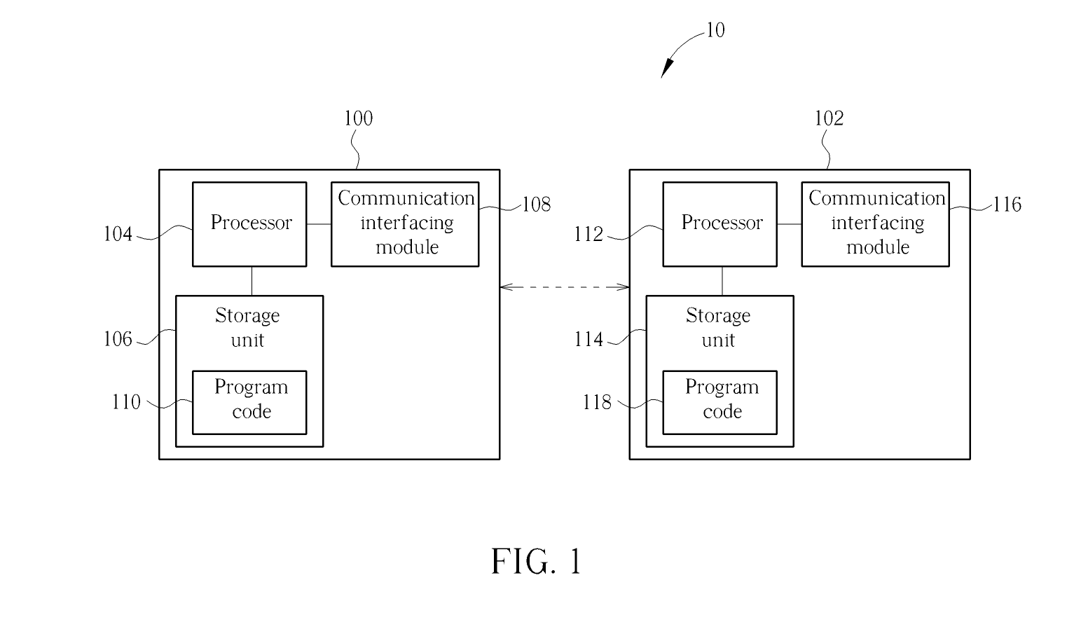

Please refer to FIG. 1, which is a schematic diagram of a wireless communications system 10 according to an example of the present invention. The wireless communications system 10 comprises a first communication apparatus 100 and a second communication apparatus 102. The first communication apparatus 100 and the second communication apparatus 102 are terminals in the wireless communications system 10 and simply utilized for illustrating the structure of the wireless communications system 10. Practically, the first communication apparatus 100 and the second communication apparatus 102 can communicate with each other by a wireless technique, such as Wireless Fidelity (Wi-Fi) or Bluetooth. For example, in a Wi-Fi system, the first communication apparatus 100 may be a source device and the second communication apparatus 102 maybe a sink device . Besides, the first communication apparatus 100 may include a processor 104 such as a microprocessor or Application Specific Integrated Circuit (ASIC), a storage unit 106 and a communication interfacing module 108. The storage unit 106 may be any data storage device that can store a program code 110, accessed and executed by the processor 104. Examples of the storage unit 106 include but are not limited to read-only memory (ROM), flash memory, random-access memory (RAM), CD-ROM/DVD-ROM, magnetic tape, hard disk and optical data storage device. The communication interfacing module 108 is preferably a transceiver and is used to transmit and receive signals (e.g., messages or packets) according to processing results of the processor 104. Further, the second communication apparatus 100 may also include a processor 112, a storage unit 114 and a communication interfacing module 116, which are similar with those included in the first communication apparatus. The storage unit 114 can store a program code 118 and be accessed and executed by the processor 112.

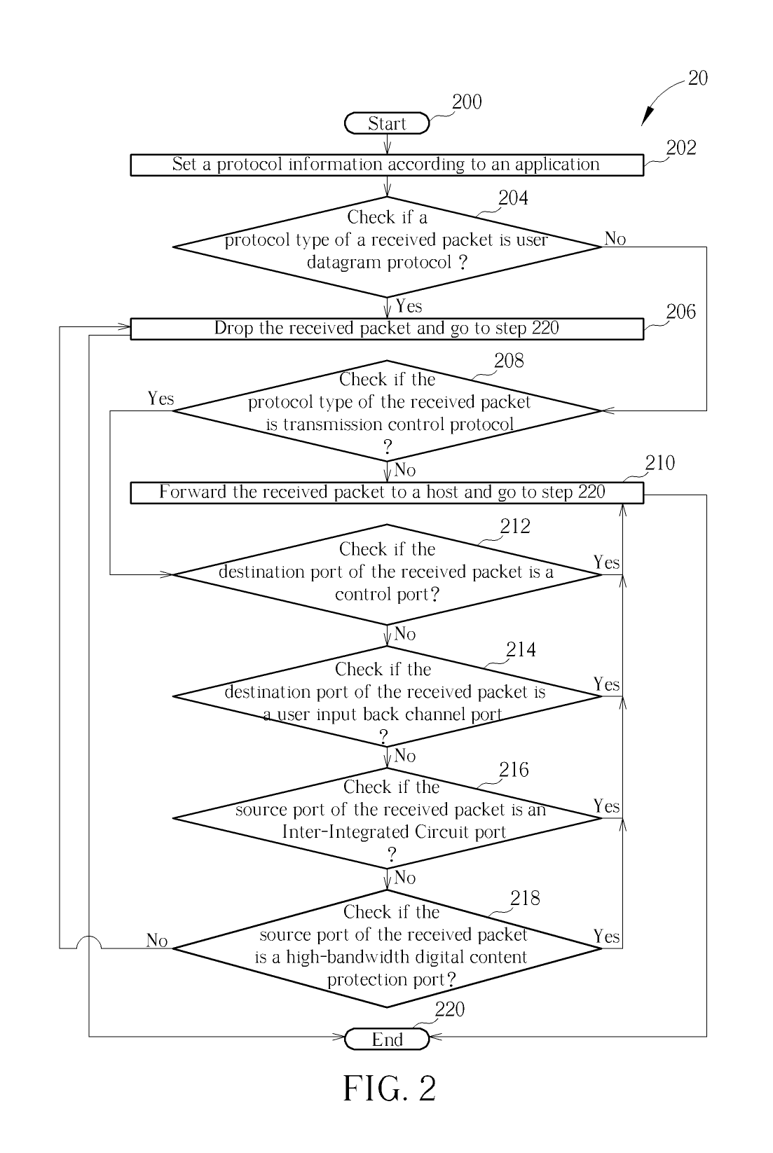

Please refer to FIG. 2, which is a flowchart of a process 20 according to an example of the present invention. The process 20 is utilized in the wireless communications system 10 shown in FIG. 1, for setting a secure connection. The process 20 can be utilized in the first communication apparatus 100, such as a source device, and may be compiled into the program code 110. The process 20 includes the following steps:

Step 200: Start.

Step 202: Set a protocol information according to an application.

Step 204: Check if a protocol type of a received packet is user datagram protocol (UDP)? If yes, go to step 206; if not, go to step 208.

Step 206: Drop the received packet and go to step 220.

Step 208: Check if the protocol type of the received packet is transmission control protocol (TCP)? If yes, go to step 212; if not, go to step 210.

Step 210: Forward the received packet to a host and go to step 220.

Step 212: Check if the destination port of the received packet is a control port? If yes, go to step 210; if not, go to step 214.

Step 214: Check if the destination port of the received packet is a user input back channel (UIBC) port? If yes, go to step 210; if not, go to step 216.

Step 216: Check if the source port of the received packet is an Inter-Integrated Circuit (I2C) port? If yes, go to step 210; if not, go to step 218.

Step 218: Check if the source port of the received packet is a high-bandwidth digital content protection (HDCP) port? If yes, go to step 210; if not, go to step 206.

Step 220: End.

According to the process 20, the first communication apparatus 100 sets the protocol information according to the application and checks the received packet according to the protocol information. If the information of the received packet does not match to the protocol information, drop the received packet; otherwise, forward the received packet to the host. Since malwares is not able to know the legal protocol information of the application in the first communication apparatus 100, the first communication apparatus 100 can resist the attack from the malwares and keep secure.

In the process 20, in the step 202, the protocol information includes the control port and combinations of the UIBC port, the I2C port or the HDCP port. Besides, in the steps 214, 216 and 218, the UIBC port, the I2C port and the HDCP port are determined via the control port.

Note that, the process 20 is an example of the present invention, and those skilled in the art should readily make combinations, modifications and/or alterations on the abovementioned description and examples. For example, the information about the control port in the protocol information is broadcast from the second communication apparatus 102 connected to the first communication apparatus 100 and scanned by the first communication apparatus 100 in the air. Besides, ports other than the UIBC port, the I2C port and the HDCP port in the protocol information can also be determined and negotiated via the control port. Moreover, the connection is built for the point-to-point transmissions, but not limited herein.

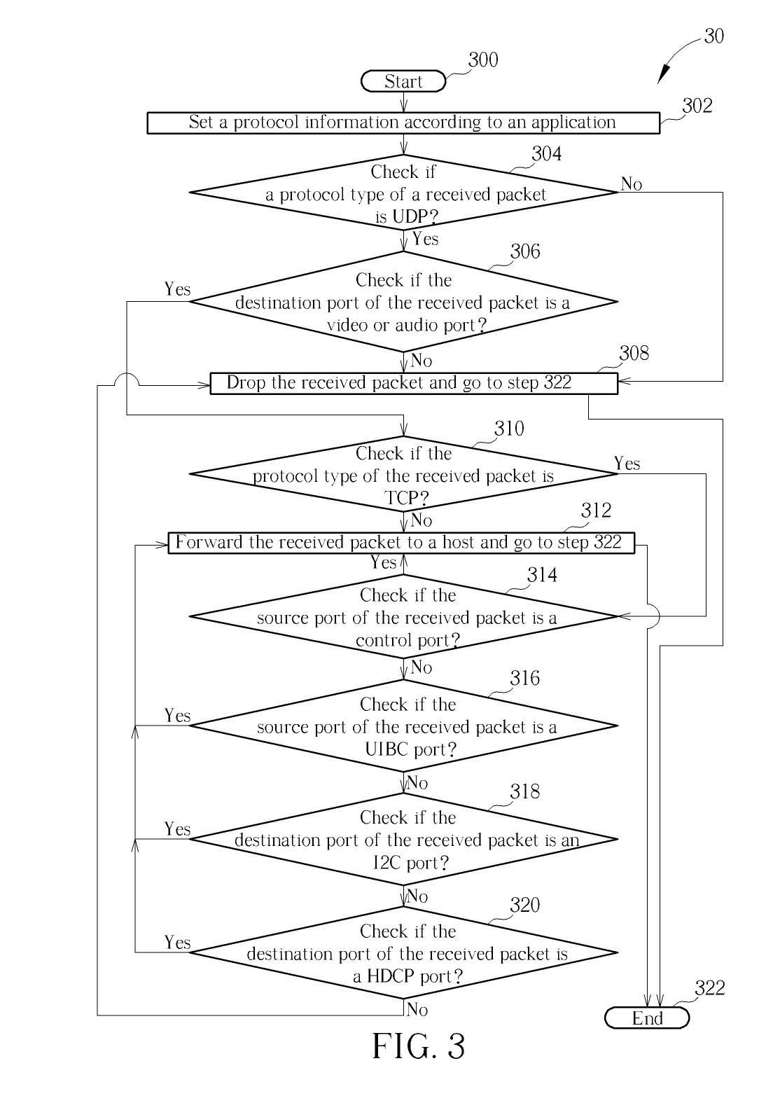

Please refer to FIG. 3, which is a flowchart of a process 30 according to an example of the present invention. The process 30 is utilized in the wireless communications system 10 shown in FIG. 1, for setting a secure connection. The process 30 can be utilized in the second communication apparatus 102, such as a sink device, and may be compiled into the program code 118. The process 30 includes the following steps:

Step 300: Start.

Step 302: Set a protocol information according to an application.

Step 304: Check if a protocol type of a received packet is UDP? If yes, go to step 306; if not, go to step 308.

Step 306: Check if the destination port of the received packet is a video or audio port? If yes, go to step 312; if not, go to step 308.

Step 308: Drop the received packet and go to step 322.

Step 310: Check if the protocol type of the received packet is TCP? If yes, go to step 314; if not, go to step 312.

Step 312: Forward the received packet to a host and go to step 322.

Step 314: Check if the source port of the received packet is a control port? If yes, go to step 312; if not, go to step 316.

Step 316: Check if the source port of the received packet is a UIBC port? If yes, go to step 312; if not, go to step 318.

Step 318: Check if the destination port of the received packet is an I2C port? If yes, go to step 312; if not, go to step 320.

Step 320: Check if the destination port of the received packet is a HDCP port? If yes, go to step 312; if not, go to step 308.

Step 322: End.

According to the process 30, the second communication apparatus 102 sets the protocol information according to the application and checks the received packet according to the protocol information. If the information of the received packet does not match to the protocol information, drop the received packet; otherwise, forward the received packet to the host. Since malwares is not able to know the legal protocol information of the application in the source device (i.e. the first communication apparatus 100), the source device can resist the attack from the malwares and keep secure.

Note that, the steps of the process 30 are similar with those of the process 20. The difference between the process 20 and the process 30 is that the second communication apparatus 102 further checks if the destination port is a video or audio port when the protocol type of the received frame is UDP. In other words, if the destination port is a video or audio port, the second communication apparatus 102 forwards the received packet to a host. If the destination port is not a video or audio port, the second communication apparatus 102 drops the received packet. Besides, the detail explanation is similar as that in the process 20, so that no more explanation is described herein.

In the present invention, the first communication apparatus 100 or the second communication apparatus 102 sets the protocol information according to the application and checks the received packet according to the protocol information. Further, the first communication apparatus 100 or the second communication apparatus 102 drops or forwards the received packet according to the checking result. Since malwares is not able to know the legal protocol information of the application in the first communication apparatus 100 or the second communication apparatus 102, the first communication apparatus 100 or the second communication apparatus 102 can resist the attack from the malwares and keep secure.

To sum up, the present invention provides a method and an apparatus for setting a secure connection, to resist the attack from the malwares and keep secure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of setting a secure connection in a wireless communications system, the method comprising:
setting a protocol information to a terminal in the wireless communication system; and
checking a packet received in the terminal according to the protocol information;
wherein the packet comprises a protocol type, a source port, and a destination port.

2. The method of claim 1, wherein the terminal is a source device.

3. The method of claim 2, further comprising dropping the packet when the protocol type of the packet is user datagram protocol.

4. The method of claim 1, wherein the terminal is a sink device.

5. The method of claim 4, further comprising checking if the destination port of the packet is a video or an audio port when the protocol type of the packet is user datagram protocol.

6. The method of claim 5, further comprising:
dropping the packet when the destination port of the packet received in the sink is not a video or an audio port; and
forwarding the packet to a host when the destination port of the packet received in the sink is a video or an audio port.

7. The method of claim 1, further comprising forwarding the packet to a host in the wireless system when the protocol type of the packet is neither user datagram protocol nor transmission control protocol.

8. The method of claim 1, further comprising checking the source port and the destination port of the packet according to the protocol information when the protocol type of the packet is transmission control protocol.

9. The method of claim 8, further comprising:
dropping the packet if the source port or the destination port of the packet is not comprised in the protocol information; and
forwarding the packet if the source port and the destination port of the packet are comprised in the protocol information.

10. The method of claim 1, wherein the protocol information comprises a control port and combinations of a user input back channel (UIBC) port, an Inter-Integrated Circuit (I2C) port or a high-bandwidth digital content protection (HDCP) port.

11. A communication apparatus for a wireless communications system, comprising:
a processor;
a storage unit;
a program code, stored in the storage unit, wherein the program code instructs the processor to execute the following steps:
setting a protocol information to a terminal in the wireless system; and
checking a packet received in the terminal according to the protocol information;
wherein the packet comprises a protocol type, a source port, and a destination port.

12. The communication apparatus of claim 11, wherein the terminal is a source device.

13. The communication apparatus of claim 12, wherein the steps further comprise:
dropping the packet when the protocol type of the packet is user datagram protocol.

14. The communication apparatus of claim 11, wherein the terminal is a sink device.

15. The communication apparatus of claim 14, wherein the steps further comprise:
checking if the destination port of the packet is a video or an audio port when the protocol type of the packet is user datagram protocol.

16. The communication apparatus of claim 15, wherein the steps further comprise:
dropping the packet when the destination port of the packet is not a video or an audio port; and
forwarding the packet to a host in the wireless system when the destination port of the packet is a video or an audio port.

17. The communication apparatus of claim 11, wherein the steps further comprise:
forwarding the packet to a host in the wireless system when the protocol type of the packet is neither user datagram protocol nor transmission control protocol.

18. The communication apparatus of claim 11, wherein the steps further comprise:
checking the source port and the destination port of the packet according to the protocol information when the protocol type of the packet is transmission control protocol.

19. The communication apparatus of claim 18, wherein the steps further comprise:
dropping the packet if the source port or the destination port of the packet is not comprised in the protocol information; and
forwarding the packet if the source port and the destination port of the packet are comprised in the protocol information.

20. The communication apparatus of claim 11, wherein the protocol information comprises a control port and combinations of a user input back channel (UIBC) port, an inter-integrated circuit (I2C) port and a high-bandwidth digital content protection (HDCP) port.
